(19) United States
(12) Patent Application Publication
(10) Pub. No.: US 2011/0102473 A1
(43) Pub. Date: May 5, 2011

(54) COLOR SEQUENTIAL DISPLAY APPARATUS AND DRIVING METHOD THEREOF

(75) Inventors: Shian-Jun Chiou, Taipei City (TW); Hun-Wei Chen, Taoyuan County (TW)

(73) Assignee: CHUNGHWA PICTURE TUBES, LTD., Taoyuan (TW)

(21) Appl. No.: 12/684,123

(22) Filed: Jan. 8, 2010

(30) Foreign Application Priority Data
Oct. 29, 2009 (TW) 98136686

(51) Int. Cl. G09G 5/10

(52) U.S. Cl. 345/690

(57) ABSTRACT

A color sequential display apparatus and a driving method thereof are provided. The color sequential display apparatus includes an image processing circuit and a display panel coupling to the image processing circuit. The image processing circuit is used to receive an image signal of a color frame to generate output signals of a plurality of fields. To be more specific, the image signal of the color frame is categorized and segmented by the image processing circuit according to a color information and the fields to generate the output signals of the fields. Besides, the output signals of the fields are further transmitted by the image processing circuit according to a predetermined color sequence. On the other hand, the display panel has a plurality of display regions. Each of the display regions receives the output signal of the corresponding field to display.

### CROSS-REFERENCE TO RELATED APPLICATION

This application claims the priority benefit of Taiwan application serial no. 98136686, filed Oct. 29, 2009. The entirety of the above-mentioned patent application is hereby incorporated by reference herein and made a part of specification.

### BACKGROUND OF THE INVENTION

1. Field of the Invention

The invention relates to a display apparatus and a driving method thereof, and more particularly to a color sequential display apparatus and a driving method thereof

2. Description of Related Art

In recent years, flat panel displays are developed rapidly owing to mature optical-electric technology and semiconductor manufacturing technology. Liquid crystal displays (LCDs) advantageous in high space-utilization efficiency, low power consumption, free radiation, and lower electromagnetic interference have gradually become a mainstream in the market. The LCD mainly includes an LCD panel and a backlight module. As the LCD panel is not self-luminescent, the backlight module must be disposed under the LCD panel to provide a surface light source required by the LCD panel, so that the LCD can display images.

The principle of providing a surface light source to the LCD panel from the backlight module of the traditional LCD is as follows. Generally, a white light is first provided, and the white light then passes through color filters inside the LCD panel to display the desired color. However, the fabrication of the color filters is time-consuming and costly, and the brightness of the white light decreases greatly after passing through the color filters. In order to maintain certain brightness, the backlight brightness must be enhanced and the power consumption must be increased.

### SUMMARY OF THE INVENTION

The invention is directed to a color sequential display apparatus and a driving method thereof. The invention is advantageous in providing superior display image, saving costs, and reducing complexity in transmission interface.

The invention is directed to a color sequential display apparatus including an image processing circuit and a display panel. The display panel is coupled to the image processing circuit. The image processing circuit receives an image signal of a color frame to generate output signals of a plurality of fields. The image signal of the color frame is categorized and segmented by the image processing circuit according to a color information and the fields to generate the output signals of the fields. The output signals of the fields are further transmitted by the image processing circuit according to a predetermined color sequence. On the other hand, the display panel has a plurality of display regions, wherein each of the display regions receives the output signal of the corresponding field to display.

The invention is directed to a driving method of a color sequential display apparatus, in which the driving method includes the following. An image processing circuit is provided to receive an image signal of a color frame to generate output signals of a plurality of fields. The image signal of the color frame is categorized and segmented by the image processing circuit according to a color information and the fields to generate the output signals of the fields. The output signals of the fields are further transmitted by the image processing circuit according to a predetermined color sequence. A display panel is provided. The display panel is coupled to the image processing circuit and has a plurality of display regions. Each of the display regions receives the output signal of the corresponding field to display.

In one embodiment of the color sequential display apparatus and the driving method thereof in the invention, the image processing circuit includes a sorting unit and a segmentation unit. The segmentation unit is coupled between the sorting unit and the display panel. The sorting unit categorizes the image signal of the color frame into image signals of a plurality of single-color fields and sorts the same according to the color information. The segmentation unit segments the display regions corresponding to the image signals of each of the single-color fields according to the color information and the fields so as to generate the output signals of the fields. In one embodiment, the single-color fields include a first color field and a second color field. The segmentation unit segments the image signal of the first color field to generate a part of the output signals of the fields corresponding to the display regions. Moreover, the segmentation unit segments the image signals of the second color field to generate another part of the output signals of the fields corresponding to the display regions. In one embodiment, the single-color fields further include a third color field. The segmentation unit segments the image signals of the third color field to generate further another part of the output signals of the fields corresponding to the display regions. In one embodiment, the image processing circuit further includes a frame memory coupled to the sorting unit and configured to store the image signals of the sorted single-color fields temporarily. In another embodiment, the image processing circuit further includes a shift unit coupled between the segmentation unit and the display panel.

In one embodiment of the color sequential display apparatus and the driving method thereof in the invention, the image processing circuit includes a sorting unit and a segmentation unit. The segmentation unit is coupled between the sorting unit and the display panel. The segmentation unit segments the image signal of the color frame into image signals of a plurality of color fields according to the color information and the fields. The color fields correspond to the display regions respectively. The sorting unit categorizes and sorts the image signals of each of the color fields so as to generate the output signals of the fields. In one embodiment, the sorting unit categorizes and sorts the image signals of one of the color fields to generate a part of the output signals of the fields. The sorting unit further categorizes and sorts the image signals of another one of the color fields to generate another part of the output signals of the fields. In one embodiment, the sorting unit categorizes and sorts the image signals of further another one of the color fields to generate further another part of the output signals of the fields. In one embodiment, the image processing circuit further includes a frame memory coupled to the sorting unit and configured to store the output signals of the sorted fields temporarily. In another embodiment, the image processing circuit further includes a shift unit coupled between the sorting unit and the display panel.

In one embodiment of the color sequential display apparatus and the driving method thereof in the invention, the image processing circuit includes a timing control circuit coupled to the display panel. The timing control circuit is configured to output the output signals of the fields generated by the image processing circuit to the display panel.

In one embodiment of the color sequential display apparatus and the driving method thereof in the invention, the color sequential display apparatus further includes a backlight module. The backlight module turns on a corresponding backlight source according to the predetermined color sequence. In one embodiment, the image processing circuit includes a timing control circuit coupled to the backlight module and the display panel. The timing control circuit is configured to output the output signals of the fields generated by the image processing circuit to the display panel. The timing control circuit is also configured to control the backlight module to turn on the backlight source corresponding to the output signals of the fields outputted by the image processing circuit.

In one embodiment of the color sequential display apparatus and a driving method thereof, the predetermined color sequence is “red-green-blue”, “red-green-blue-green”, “red-green-blue-white”, “red-green-blue-white-yellow”, or “red-green-blue-cyan-yellow-magenta”.

In light of the foregoing, the image processing circuit in the color sequential display apparatus of the invention is capable of sorting, segmenting, and transmitting the received image signals of the color frames according to the color information and the predetermined color sequence. Therefore, the color sequential display apparatus of the invention simplifies the complexity of the transmission interface to provide superior display image for reducing power consumption so as to reduce costs.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1A′ are schematic block diagrams illustrating two color sequential display apparatuses in a first embodiment of the invention.

FIGS. 1B˜1D are schematic diagrams illustrating three types of display panels according to an embodiment of the invention.

FIG. 1E shows a schematic block diagram of a computer system in the first embodiment of the invention.

FIGS. 2 and 2′ are schematic block diagrams illustrating two color sequential display apparatuses in a second embodiment of the invention.

FIGS. 3, 3′, 3A, and 3A′ are schematic block diagrams illustrating four types of color sequential display apparatuses in a third embodiment of the invention.

FIGS. 4A, 4A′, 4B, and 4B′ are schematic block diagrams illustrating four types of color sequential display apparatuses in a fourth embodiment of the invention.

FIGS. 5 and 5′ are schematic block diagrams illustrating two color sequential display apparatuses in a fifth embodiment of the invention.

FIGS. 6A, 6A′, 6B, and 6B′ are schematic block diagrams illustrating four types of color sequential display apparatuses in a sixth embodiment of the invention.

FIGS. 7A, 7A′, 7B, and 7B′ are schematic block diagrams illustrating four types of color sequential display apparatuses in a seventh embodiment of the invention.

FIGS. 8A, 8A′, 8B, and 8B′ are schematic block diagrams illustrating four types of color sequential display apparatuses in an eighth embodiment of the invention.

FIG. 9 illustrates a flowchart of a driving method of a color sequential display apparatus according to an embodiment of the invention.

### DESCRIPTION OF THE EMBODIMENTS

### The First Embodiment

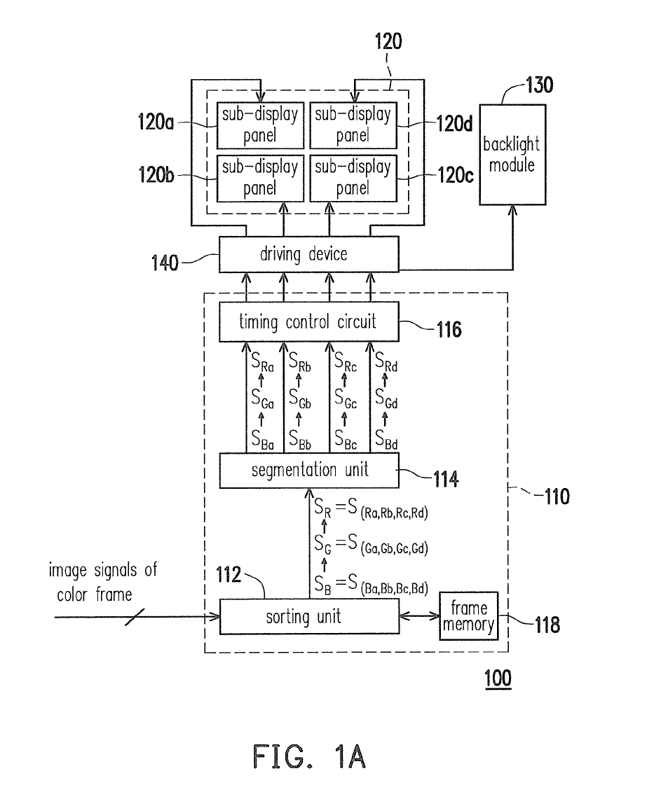

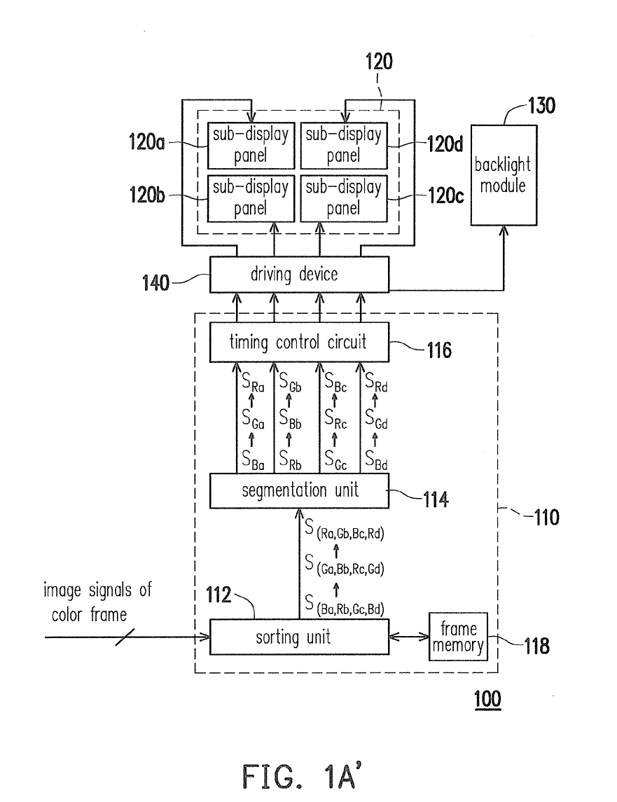

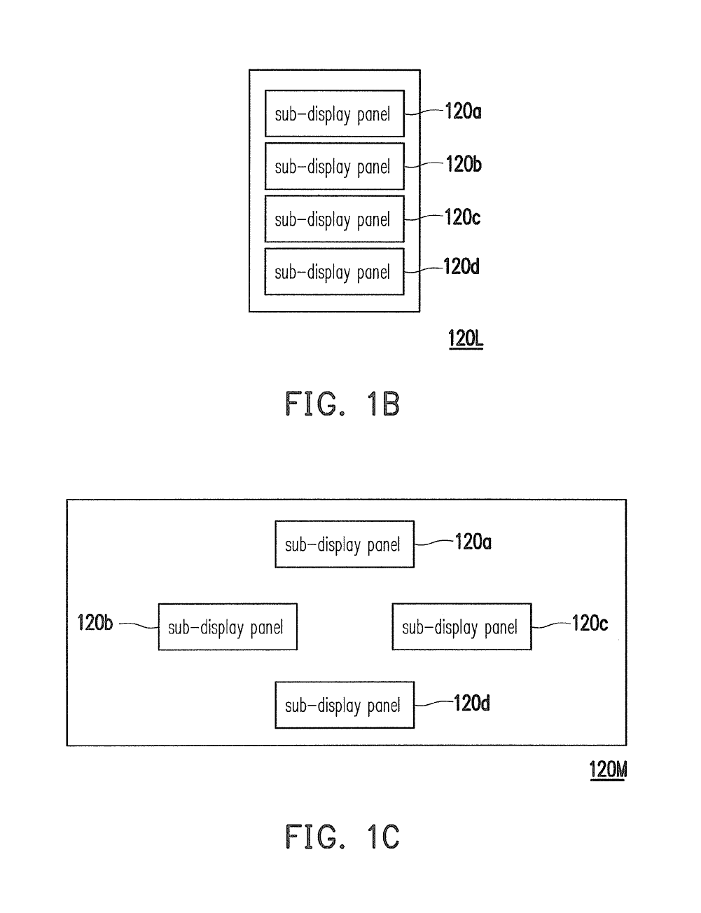

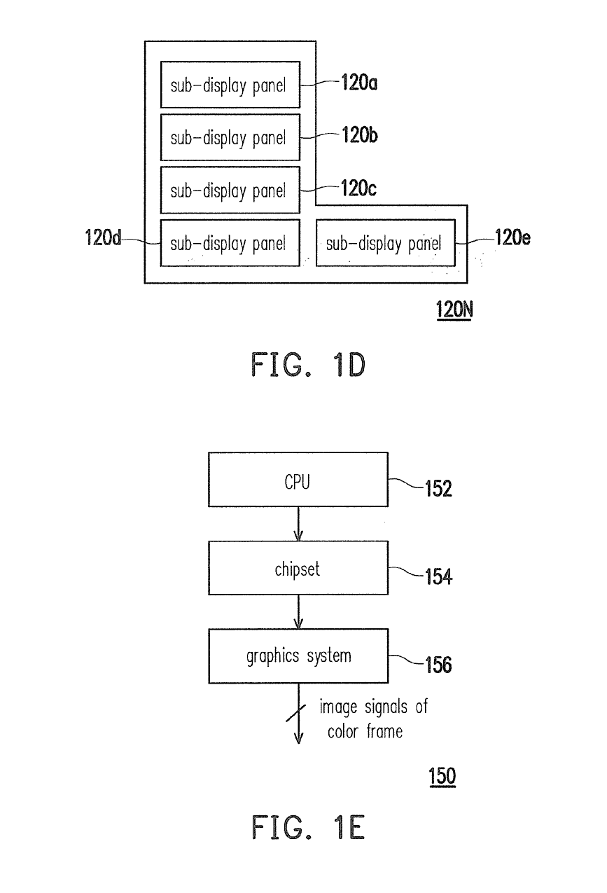

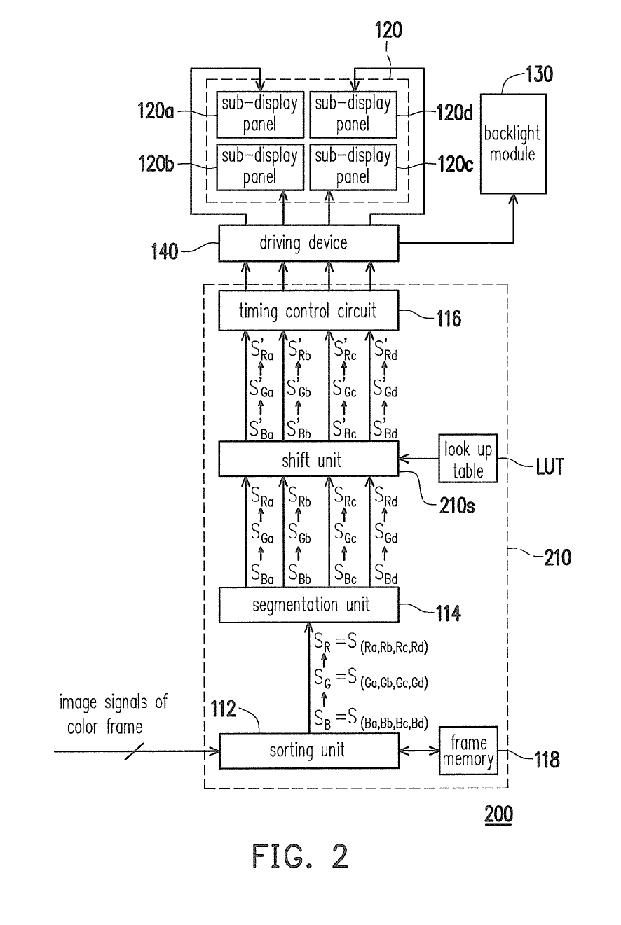

FIG. 1A is schematic block diagram illustrating a color sequential display apparatus in a first embodiment of the invention. Referring to FIG. 1A, a color sequential display apparatus 100 of the present embodiment includes an image processing circuit 110 and a display panel 120. The display panel 120 having a plurality of display regions is coupled to the image processing circuit 110. In the present embodiment, the display panel 120 has four display regions. The four display regions display images through sub-display panels 120a, 120b, 120c, and 120d respectively.

However, the division of the display panel 120 into four display regions and an arrangement of the sub-display panels 120a, 120b, 120c, and 120d in the present embodiment are merely exemplary, and the invention is not limited thereto. For example, the sub-display panels 120a, 120b, 120c, and 120d are also arranged as those shown in display panels 120L and 120M in FIG. 1B and FIG. 1C. Moreover, a display panel 120N illustrated in FIG. 1D and the sub-display panels 120a, 120b, 120c, 120d, and 120e thereof further show that the invention does not limit the shape of the display panel and the number of the sub-display panels. To simplify the illustration, the descriptions are omitted herein. In the following, the display panel 120 having four display regions is mainly utilized for illustration.

The color sequential display apparatus 100 further includes a backlight module 130 and a driving device 140 (i.e. a gate driver, a source driver, etc.). The backlight module 130 provides a light source required by the display panel 120. The driving device 140 electrically connects to the display panel 120. In practical use, the display image of each of the sub-display panels 120a, 120b, 120c, and 120d is controlled by a set of driving devices (i.e. a gate driver and a source driver) and a timing control circuit. Also, the same timing control circuit can be used to control each of the sub-display panels 120a, 120b, 120c, and 120d. Obviously, the color sequential display apparatus 100 further includes other components. In the present embodiment, only relevant components are illustrated in the following.

In the backlight module 130, the corresponding backlight source is turned on according to a predetermined color sequence so as to provide a desirable colored light at a desirable time point. In details, the predetermined color sequence of the present embodiment is adopted as a lighting color sequence when lighting the backlight source. For example, when the predetermined color sequence is “R (red)-G (green)-B (blue)”, the backlight source is lighted in a sequence of “red backlight→green backlight→blue backlight”. Alternatively, the predetermined color sequence can also adopt modes such as “R-G-B-G”, “R-G-B-W (white)”, “R-G-B-W-Y (yellow)”, “R-G-B-C-Y-M (magenta)”, and so on. The predetermined color sequence can also be other modes, and is not described in details here.

In the present embodiment, the color image a user sees on the display panel 120 is actually assembled by color images respectively displayed by the sub-display panels 120a, 120b, 120c, and 120d. Thus, each color image to be displayed must be divided into four sub-display images. The four sub-display images are then combined to represent a visual effect of a complete color image. For the simplicity of illustration, the color image to be displayed is referred as a color frame in the following.

In the present embodiment, the image processing circuit 110 first receives an image signal of a color frame. The image signal of the color frame is generated through a personal computer (PC) system 150 disposed outside of the image processing circuit 110, as shown in FIG. 1E. In other embodiments, the generation of the image signas of the color frame is also achieved through a video board (or a scalar board).

In the present embodiment, the PC system 150 is constituted of components such as a central processing unit (CPU) 152, a chipset 154, and a graphics system 156. However, the invention is not limited thereto.

It should be noted that the image signals of the present embodiment includes a control signal, a scanning signal required by the display panel 120 when displaying, an image synchronization signal, a data signal, and the like. The present embodiment mainly illustrates the data signal, and the type of the image signals in the invention, however, is not limited herein. The image processing circuit 110 then categorizes and segments the image signal of the color frame to generate output signals of a plurality of fields (to be illustrated later). Next, the display panel 120 displays the color image to be displayed, that is, the color frame, by receiving the output signals of the fields.

Specifically, as shown in FIG. 1A, the image processing circuit 110 of the present embodiment includes a sorting unit 112, a segmentation unit 114 and a timing control circuit 116. In the present embodiment, the segmentation unit 114 is coupled between the sorting unit 112 and the display panel 120. The timing control circuit 116 is coupled between the segmentation unit 114 and the display panel 120.

When the predetermined color sequence (the lighting sequence) adopted by the color sequential display apparatus 100 is “R-G-B”, the color information thereof is then “red, green, and blue”. Therefore, the sorting unit 112 is capable of sorting the image signal of the color frame into image signals of a plurality of single-color fields according to this color information “red, green, and blue”. That is, the image signal of the color frame is sorted to be an image signal S_{R} of a red field, an image signal S_{G} of a green field, and an image signal S_{B} of a blue field. Additionally, the sorting unit 112 further sorts the image signals of the single color fields into “the image signal S_{R} of the red field→the image signal S_{G} of the green field→the image signal S_{B} of the blue field”.

Generally, a frame memory 118 coupled to the sorting unit 112 is usually disposed in the image processing circuit 110. Here, the frame memory 118 is configured to store the image signals S_{R}, S_{G}, and S_{B} of the sorted red field, green field, and blue field. In practical use, one or more synchronous dynamic random access memory (SDRAM) is adopted as the frame memory 118. However, the invention is not limited thereto.

Thereafter, the segmentation unit 114 further segments the image signals S_{R}, S_{G}, and S_{B} of the red field, green field, and blue field. In the present embodiment, the sub-display panels 120a, 120b, 120c, and 120d respectively display the upper left portion, the bottom left portion, the bottom right portion, and the upper right portion of the color frame. Thus, each single-color field (red, green, blue field) has to be segmented into four parts of upper left, bottom left, bottom right, and upper right. The segmented field signals (to be illustrated later) are then transmitted to the sub-display panels 120a, 120b, 120c, and 120d respectively.

More specifically, the segmentation unit 114 segments the image signal S_{R} of the red field into output signals S_{Ra}, S_{Rb}, S_{Rc}, and S_{Rd} of four fields. Furthermore, the image signal S_{G} of the green field is segmented into output signals S_{Ga}, S_{Gb}, S_{Gc}, and S_{Gd} of four fields. The image signal S_{B} of the blue field is segmented into output signals S_{Ba}, S_{Bb}, S_{Bc}, and S_{Bd} of four fields. Herein, the output signals S_{Ra}, S_{Ga}, and S_{Ba} of the fields are transmitted to the sub-display panel 120a sequentially. The output signals S_{Rb}, S_{Gb}, and S_{Bb} of the fields are transmitted to the sub-display panel 120b sequentially. The output signals S_{Rc}, S_{Gc}, and S_{Bc} of the fields are transmitted to the sub-display panel 120c sequentially. Finally, the output signals S_{Rd}, S_{Gd}, and S_{Bd} of the fields are transmitted to the sub-display panel 120d sequentially. In the present embodiment, the output signals S_{Ra}, S_{Ga}, S_{Ba}, S_{Rb}, S_{Gb}, S_{Bb}, S_{Rc}, S_{Bc}, S_{Bc}, S_{Rd}, S_{Gd}, and S_{Bd} of the fields are outputted to the display panel 120 through the timing control circuit 116.

Accordingly, in the present embodiment, after the image processing circuit 110 receives any one of the color frames, the sorting unit 112 and the segmentation unit 114 then sort and segment the color frame to generate the output signals S_{Ra}, S_{Ga}, S_{Ba}, S_{Rb}, S_{Gb}, S_{Bb}, S_{Rc}, S_{Gc}, S_{Bc}, S_{Rd}, S_{Bd}, S_{Bd} of the fields required by the display panel 120. Obviously, when the color image is to be display continuously, the image processing circuit 110 has to receive image signals of a plurality of color frames sequentially. For example, the image signals of the color frames are received with a frame rate of 60 Hz. Afterwards, the image processing circuit 110 sequentially sorts and segments the image signals of the color frames, wherein the image signals are then transmitted to the display panel 120. Here, the output signals (i.e. S_{Ra}, S_{Ga}, or S_{Ba}) of 60 single-color fields are outputted to the display panel 120 every second, for example. That is, the field rate is 180 Hz.

It should be noted that in the aforementioned embodiment, the image signals S_{R}, S_{G}, and S_{B} of the red, green, and blue fields are respectively S_{(Ra, Rb, Rc, Rd)}, S_{(Ga, Gb, Gc, Gd)}, and S_{(Ba, Bb, Bc, Bd)}. Moreover, the corresponding color sequences respectively received by the sub-display panels 120a, 120b, 120c, and 120d are the same. That is, the color sequences are all red green-4 blue, for example.

However, in other embodiments, the image signals of the red, green, and blue fields are respectively S_{(Ra, Gb, Bc, Rd)}, S_{(Ga, Bb, Rc, Gd)}, and S_{(Ba, Rb, Gc, Bd)}. Also, the corresponding color sequences respectively received by the sub-display panels 120a, 120b, 120c, and 120d can be different. For example, referring to the schematic block diagram shown in FIG. 1A′, the corresponding color sequence of the signal received by the sub-display panel 120a is red→green→blue (that is, S_{Ra}→S_{Ga}→S_{Ba}). In addition, the corresponding color sequence of the signal received by the sub-display panel 120b is green→blue→red (that is, S_{Gb}→S_{Bb}→S_{Rb}). The corresponding color sequence of the signal received by the sub-display panel 120c is blue→red→green (that is, S_{Bc}→S_{Rc}→S_{Gc}). The corresponding color sequence of the signal received by the sub-display panel 120d is red→green→blue (that is, S_{Rd}→S_{Gd}→S_{Bd}).

Accordingly, the design of the color sequential display apparatus is also illustrated in the following embodiments. For the convenience of illustration, most of the predetermined color sequences adopted in the following embodiments are “R-G-B”, so the color information is “red, green, and blue”. However, the invention is not limited herein.

### The Second Embodiment

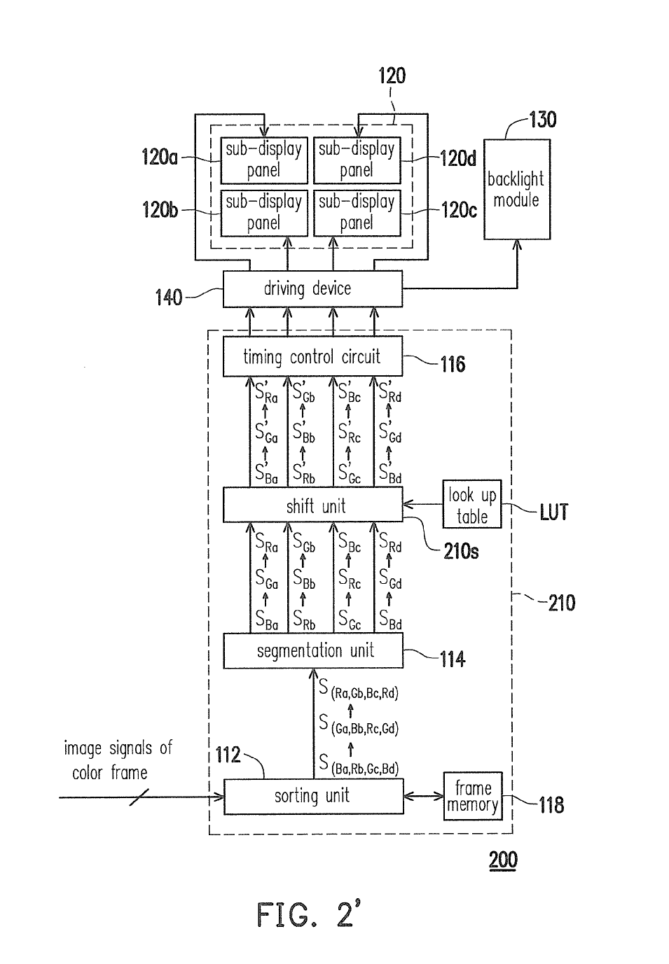

The concept to be illustrated in the present embodiment is similar to that of the first embodiment. The main difference between the two is that, in the present embodiment, a shift unit 210S is further disposed in an image processing circuit 210 as shown in a color sequential display apparatus 200 of FIG. 2. The same or similar reference numbers used in the present embodiment and in the aforementioned embodiment represent the same or the like components, and therefore no further description is provided herein.

As shown in FIG. 2, due to the mechanical restraint between two adjacent sub-display panels (i.e. between 120a and 120b), the image ratio of the display image between two adjacent sub-display panels is affected. In order to enhance the overall quality of the display image and to correctly represent the image ratio to be displayed, the shift unit 210S is disposed to shift the display image in the present embodiment.

In the present embodiment, the shift unit 210S is coupled between the segmentation unit 114 and display panel 120. The shift unit 210S receives the output signals S_{Ra}, S_{Ga}, S_{Ba}, S_{Rb}, S_{Gb}, S_{Bb}, S_{Rc}, S_{Gc}, S_{Bc}, S_{Rd}, S_{Gd}, S_{Bd} of the fields outputted by the segmentation unit 114, and then performs the image shift to generate output signals S′_{Ra}, S′_{Ga}, S′_{Ba}, S′_{Rb}, S′_{Gb}, S′_{Bb}, S′_{Rc}, S′_{Gc}, S′_{Bc}, S′_{Rd}, S′_{Gd}, S′_{Bd} of the fields. The output signals S′_{Ra}, S′_{Ga}, S′_{Ba}, S′_{Rb}, S′_{Gb}, S′_{Bb}, S′_{Rc}, S′_{Gc}, S′_{Bc}, S′_{Rd}, S′_{Gd}, S′_{Bd} of the fields are then transmitted to the display panel 120. Here, the sub-display panel 120a received the output signals S′_{Ra}, S′_{Ga}, and S′_{Ba} of the fields, the sub-display panel 120b receives the output signals S′_{Rb}, S′_{Gb}, and S′_{Bb} of the fields, the sub-display panel 120c receives the output signals S′_{Rc}, S′_{Gc}, and S′_{Bc} of the fields, and the sub-display panels 120d receives the output signals S′_{Rd}, S′_{Gd}, S^{′}_{Bd} of the fields.

Practically, the shift unit 2105 couples to a look up table (LUT) which is configured to shift signals, so as to shift images. The details of the color sequential display apparatus 200 of the present embodiment can refer to the first embodiment, and the description is thus omitted herein.

It should be noted that in the present embodiment, the image signals S_{R}, S_{G}, and S_{B} of the red, green, and blue fields are transmitted in the sequence of S_{(Ra, Rb, Rc, Rd)}, S_{(Ga, Gb, Gc, Gd)}, and S_{(Ba, Bb, Bc, Bd)}. Moreover, the corresponding color sequences (i.e. red→green→blue) respectively received by the sub-display panels 120a, 120b, 120c, and 120d are all the same.

However, in other embodiments, the image signals of the red, green, and blue fields are transmitted in the sequence of S_{(Ra, Gb, Bc, Rd)}, S_{(Ga, Bb, Rc, Gd)}, and S_{(Ba, Rb, Gc, Bd)}.

Accordingly, the corresponding color sequences respectively received by the sub-display panels 120a, 120b, 120c, and 120d can be different. For example, referring to the schematic block diagram shown in FIG. 2′, the corresponding color sequence of the signal received by the sub-display panel 120a is red→green→blue (that is, S′_{Ra}→′S_{Ga}→′S_{Ba}). In addition, the corresponding color sequence of the signal received by the sub-display panel 120b is green→blue→red (that is, S′_{Gb}→S′_{Bb}S→_{Rb}). The corresponding color sequence of the signal received by the sub-display panel 120c is blue→red→green (that is, S′_{Bc}→S′_{Rc}→S′_{Gc}). The corresponding color sequence of the signal received by the sub-display panel 120d is red→green→blue (that is, S′_{Rd}→S′_{Gd}→S′_{Bd}).

### The Third Embodiment

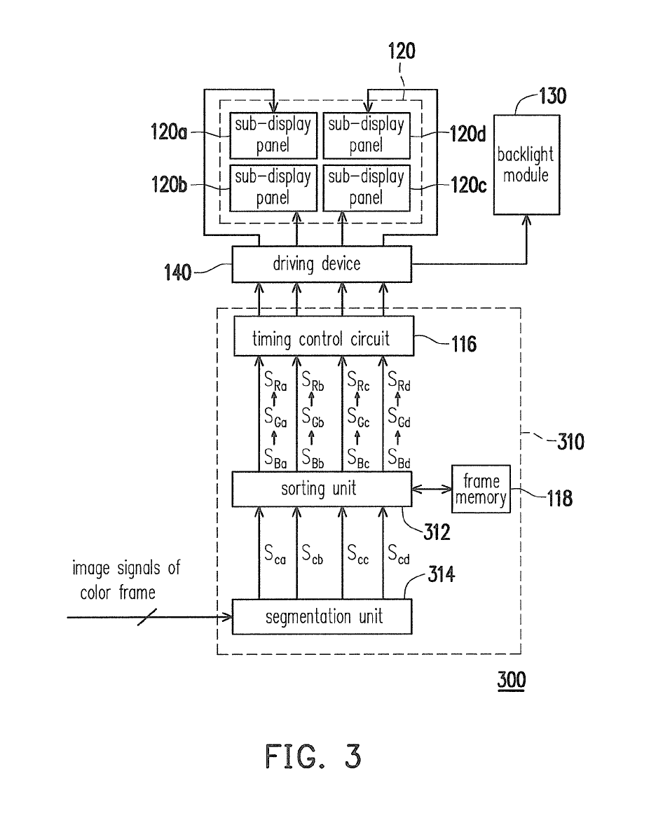

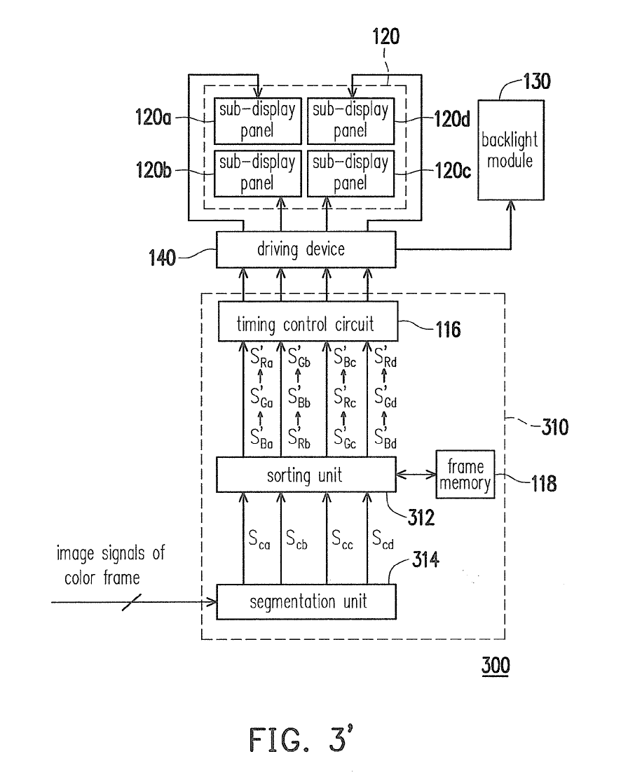

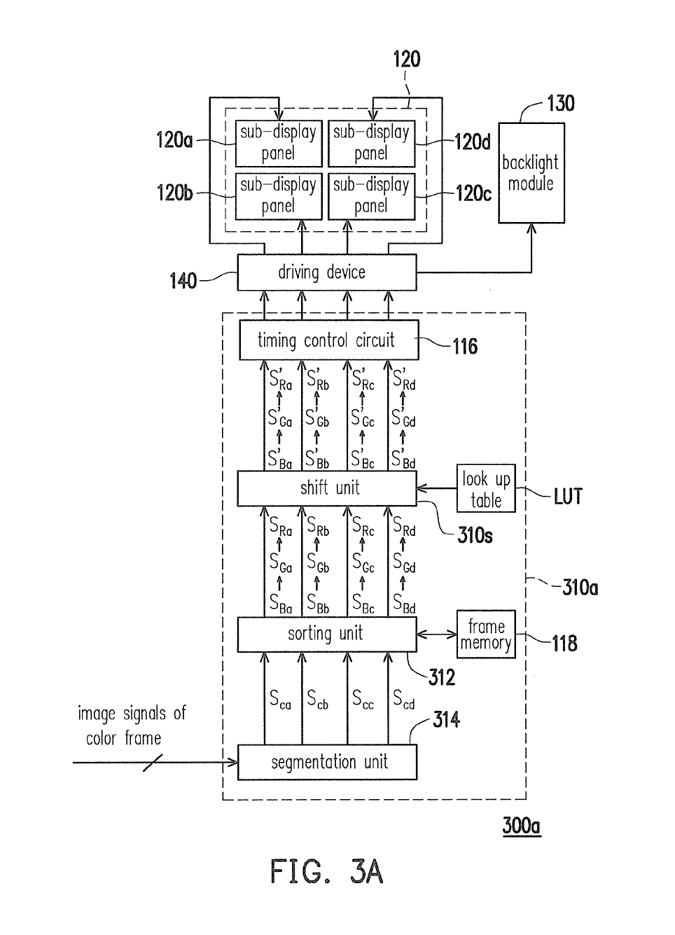

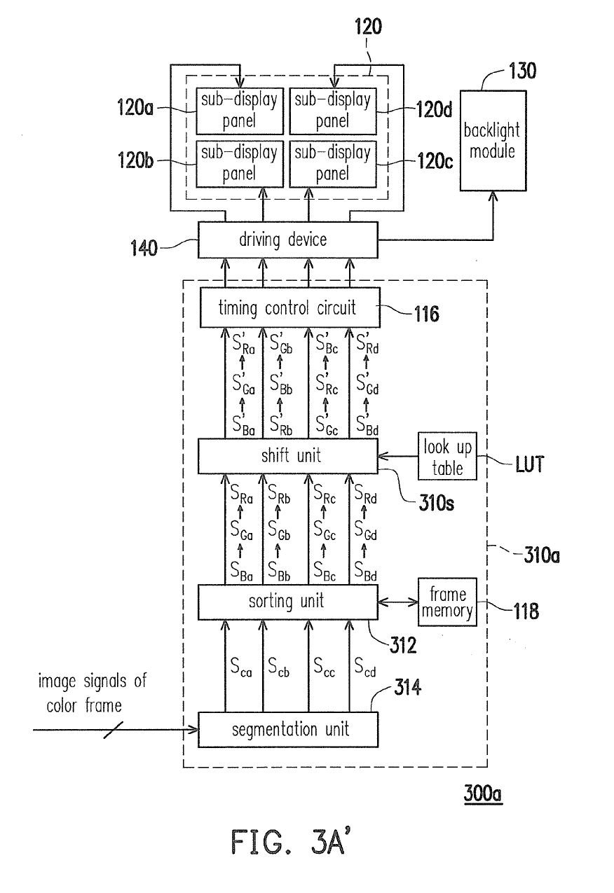

The concept to be illustrated in the present embodiment is similar to that of the first embodiment. The main difference between the two is that, in a color sequential display apparatus 300 of the present embodiment, a sorting unit 312 is coupled between the segmentation unit 314 and the display panel 120 as shown in FIG. 3. Additionally, the same or similar reference numbers used in the present embodiment and in the aforementioned embodiment represent the same or the like components, and therefore no further description is provided herein.

In the present embodiment, after an image processing circuit 310 receives an image signal of any one of the color frames, the segmentation unit 314 first segments the image signal of the color frame into image signals (to be described later) of a plurality of color fields. Thereafter, the sorting unit 312 categorizes and sorts the image signals of the color fields.

In details, the color image displayed by the display panel 120 of the present embodiment is actually assembled by the color images respectively displayed by the sub-display panels 120a, 120b, 120c, and 120d. The segmentation unit 314 then segments the image signal of the color frame into the image signals S_{ca}, S_{cb}, S_{cc}, and S_{cd} of the four color fields corresponding to the sub-display panels 120a, 120b, 120c, and 120d.

In the present embodiment, when the predetermined color sequence (the lighting sequence) adopted by the color sequential display apparatus 300 is “R-G-B”, the color information thereof is “red, green, and blue”. The predetermined color sequence and the color information can also be other modes, and is not described in details here.

The sorting unit 312 categorizes the image signals S_{ca}, S_{cb}, S_{cc}, and S_{cd} of the color fields into output signals of a plurality of fields according to the color information “red, green, and blue”. In other words, the sorting unit 312 categorizes the image signal S_{ca} of the color field to represent the output signals S_{Ra}, S_{Ga}, and S_{Ba} of the red, green, and blue fields respectively, the image signal S_{cb} of the color field to represent the output signals S_{Rb}, S_{Gb}, and S_{Bb} of the red, green, and blue fields respectively, the image signal S_{cc} of the color field to represent the output signals S_{Rc}, S_{Gc}, and S_{Bc} of the red, green, and blue fields respectively, and the image signal S_{cd} of the color field to represent the output signals S_{Rd}, S_{Gd}, and S_{Bd} of the red, green, and blue fields respectively.

Furthermore, the sorting unit 312 further sorts the output signals of the fields mentioned above into “S_{Ra}→S_{Ga}→S_{Ba}”, “S_{Rb}→S_{Gb}→S_{Bb}”, “S_{Rc}→S_{Gc}→S_{Bc}”, and “S_{Rd}→S_{Gd}→S_{Bd}”. In practice, a frame memory 118 coupled to the sorting unit 312 is usually disposed in the image processing circuit 310. Here, the frame memory 118 is configured to store the output signals “S_{Ra}→S_{Ga}→S_{Ba}”, “S_{Rb}→S_{Gb}→S_{Bb}”, “S_{Rc}→S_{Gc}→S_{Bc}”, and “S_{Rd}→S_{Gd}→S_{Bd}” of the sorted fields temporarily

Consequently, the output signals S_{Ra}, S_{Ga}, and S_{Ba} of the fields are transmitted to the sub-display panel 120a sequentially. The output signals S_{Rb}, S_{Gb}, and S_{Bb} of the fields are transmitted to the sub-display panel 120b sequentially. The output signals S_{Rc}, S_{Gc}, and S_{Bc} of the fields are transmitted to the sub-display panel 120c sequentially. Finally, the output signals S_{Rd}, S_{Gd}, and S_{Bd} of the fields are transmitted to the sub-display panel 120d sequentially. In the present embodiment, the output signals S_{Ra}, S_{Ga}, S_{Ba}, S_{Rb}, S_{Gb}, S_{Bb}, S_{Rc}, S_{Gc}, S_{Bc}, S_{Rd}, S_{Gd}, S_{Bd} of the fields are outputted to the display panel 120 through the timing control circuit 116 coupled between the sorting unit 312 and the display panel 120.

However, in other embodiments, a shift unit 3105 is further disposed in an image processing circuit 310a, as shown in a color sequential display apparatus 300a of FIG. 3A, to enhance the overall quality of the display image. The shift unit 310S is coupled between the sorting unit 312 and the display panel 120. The shift unit 310S is configured to perform the image shift so as to convert the output signals S_{Ra}, S_{Ga}, S_{Ba}, S_{Rb}, S_{Gb}, S_{Bb}, S_{Rc}, S_{Gc}, S_{Bc}, S_{Rd}, S_{Gd}, S_{Bd} of the fields into the signals S′_{Ra}, S′_{Ga}, S′_{Ba}, S′_{Rb}, S′_{Gb}, S′_{Bb}, S′_{Rc}, S′_{Gc}, S′_{Bc}, S′_{Rd}, S′_{Gd}, S′_{Bd}. The signals S′_{Ra}, S′_{Ga}, S′_{Ba}, S′_{Rb}, S′_{Gb}, S′_{Bb}, S′_{Rc}, S′_{Gc}, S′_{Bc}, S′_{Rd}, S′_{Gd}, S′_{Bd} of the fields are then transmitted to the timing control circuit 116.

Nevertheless, the details of the color sequential display apparatuses 300, 300a can refer to the first and the second embodiments, and the description is thus omitted herein.

Notably, in the present embodiment, the corresponding color sequences (i.e. red→green→blue) of the signals received by the sub-display panels 120a, 120b, 120c, and 120d respectively are all the same. In other embodiments, the corresponding color sequences of the signals received by the sub-display panels 120a, 120b, 120c, and 120d respectively can be all different.

For example, referring to the schematic block diagrams shown in FIG. 3′ and FIG. 3A′, the corresponding color sequence of the signal received by the sub-display panel 120a is red→green→blue (that is, S_{Ra}→S_{Ga}→S_{Ba} in FIG. 3′ and S′_{Ra}→S′_{Ga}→S′_{Ba} in FIG. 3A). In addition, the corresponding color sequence of the signal received by the sub-display panel 120b is green→blue→red (that is, S_{Gb}→S_{Bb}→S_{Rb} in FIG. 3′ and S′_{Gb}→S′_{Bb}→S′_{Rb} in FIG. 3A′). The corresponding color sequence of the signal received by the sub-display panel 120c is blue→red→green (that is, S_{Bc}→S_{Rc}→S_{Gc} in FIG. 3′ and S^{′}_{Bc}→S′_{Rc}→S′_{Gc} in FIG. 3A′). The corresponding color sequence of the signal received by the sub-display panel 120d is red→green→blue (that is, S_{Rd}→S_{Gd}→S_{Bd} in FIG. 3 and S′_{Rd}→S′_{Gd}→S′_{Bd} in FIG. 3A).

### The Fourth Embodiment

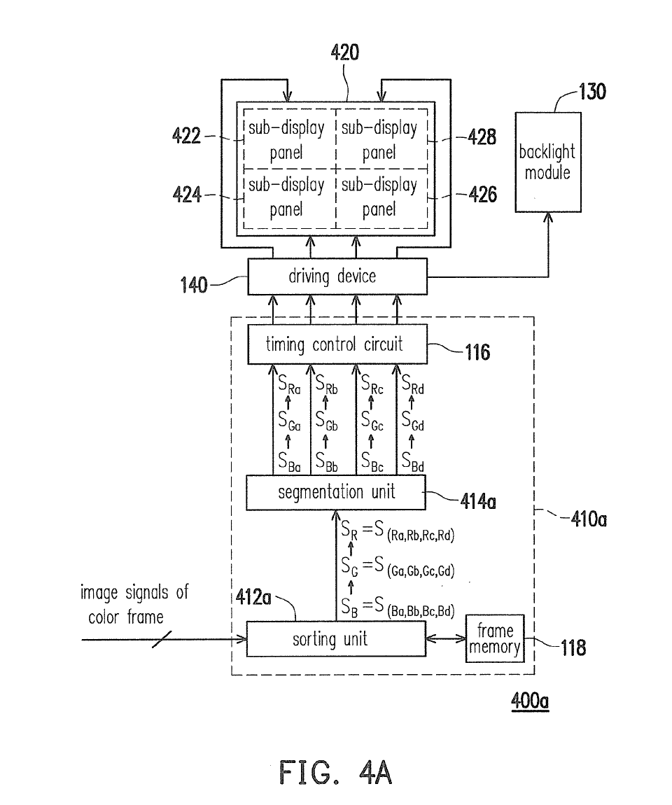

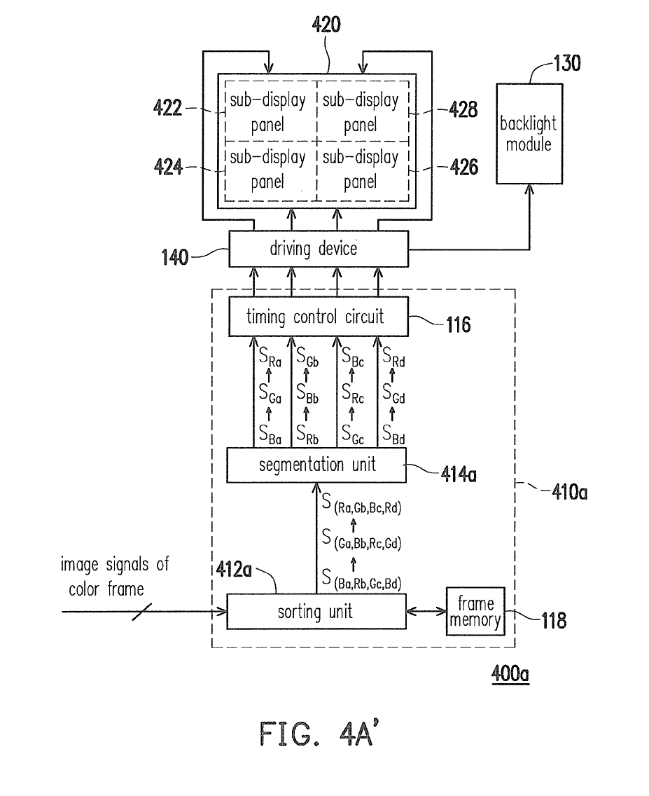

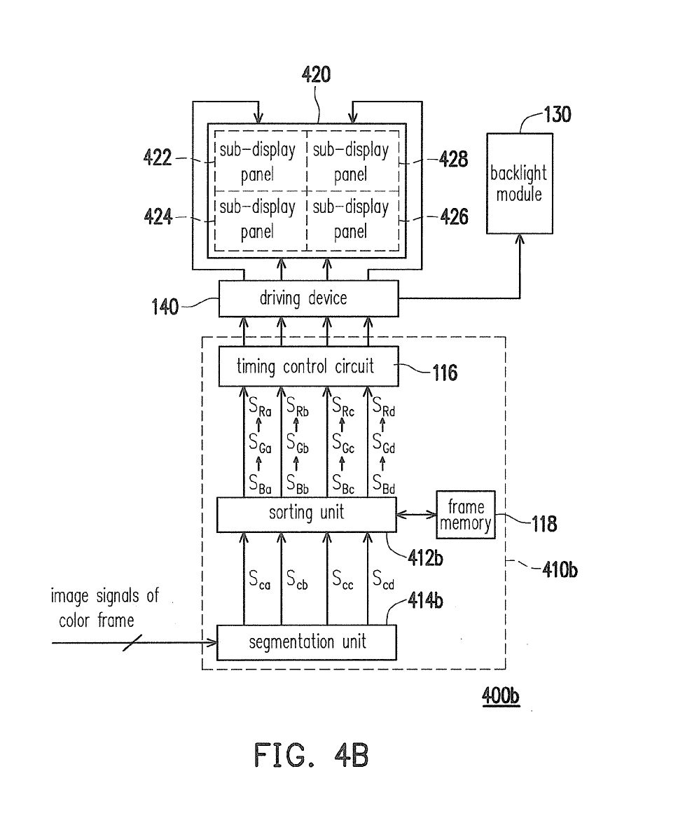

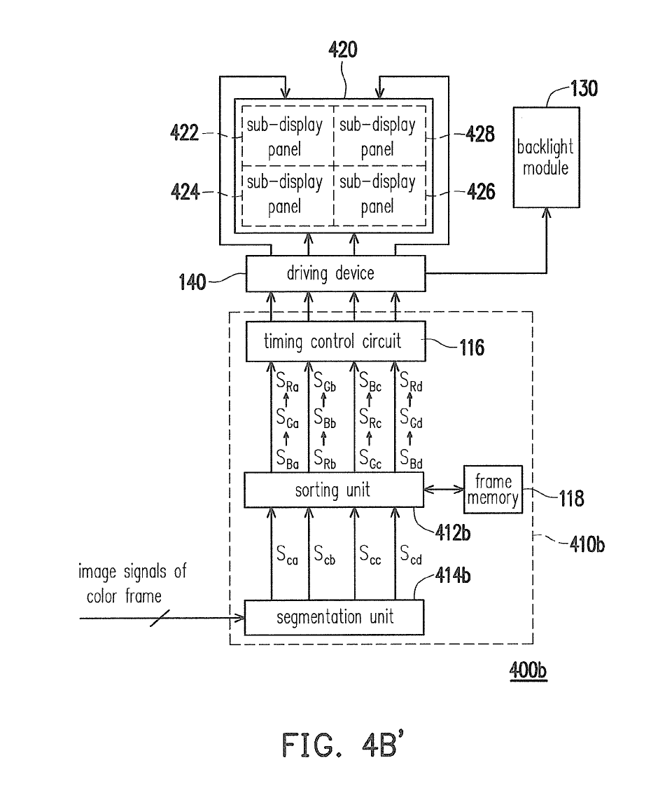

The concept to be illustrated in a color sequential display apparatus 400a (shown in FIG. 4A) of the present embodiment is similar to that of the color sequential display apparatus 100 (shown in FIG. 1A) of the first embodiment. The main difference between the two is that in the present embodiment, a plurality of sub-display panels are integrated into a display panel 420. The display panel 420 has a plurality of display regions (to be described later). Additionally, the same or similar reference numbers used in the present embodiment and in the aforementioned embodiment represent the same or the like components, and therefore no further description is provided herein.

In the present embodiment, the display panel 420 has four display regions 422, 424, 426 and 428. The display regions 422, 424, 426, and 428 display the upper left portion, the bottom left portion, the bottom right portion, and the upper right portion of the color frame (the color image to be displayed) respectively. Obviously, the invention does not limit the display panel to be divided into four portions, and the number of division is determined upon actual requirements.

In an image processing circuit 410a, a segmentation unit 414a is coupled between the sorting unit 412a and the display panel 420. The image processing circuit 410a receives the image signal of each of the color frames, and categorizes and segments the same to generate the output signals S_{Ra}, S_{Ga}, S_{Ba}, S_{Rb}, S_{Gb}, S_{Bb}, S_{Rc}, S_{Gc}, S_{Bc}, S_{Rd}, S_{Gd}, S_{Bd} of a plurality of fields. The output signals S_{Ra}, Sₑₐ, S_{Ba}, S_{Rb}, S_{Gb}, S_{Bb}, S_{Rc}, S_{Gc}, S_{Bc}, S_{Rd}, S_{Gd}, S_{Bd} are then transmitted to a display panel 420. The display region 422 receives the output signals S_{Ra}, S_{Ga}, S_{Ba} of the fields. The display region 424 receives the output signals S_{Rb}, S_{Gb}, S_{Bb} of the fields. The display region 426 receives the output signals S_{Rc}, S_{Gc}, S_{Bc} of the fields. Moreover, the display region 428 receives the output signals S_{Rd}, S_{Gd}, S_{Bd} of the fields. The details of the color sequential display apparatus 400a of the present embodiment can refer to the first embodiment, and the description is thus omitted herein.

It should be noted that in other embodiments, positions of the sorting unit and the segmentation unit in FIG. 4A can be interchanged to form a color sequential display apparatus 400b as depicted in FIG. 4B. Further, in an image processing circuit 410b, a sorting unit 412b is coupled between the segmentation unit 414b and the display panel 420. The details of the image processing circuit 410b can refer to the color sequential display apparatus 300 in the third embodiment, and the description is thus omitted herein.

It should be noted that in the present embodiment, the image signals S_{R}, S_{G}, and S_{B} of the red, green, and blue fields are respectively S_{(Ra, Rb, Rc, Rd)}, S_{(Ga, Gb, Gc, Gd)}, and S_{(Ba, Bb, Bc, Bd)}. Moreover, the corresponding color sequences (i.e. red→green→blue) respectively received by the display regions 422, 424, 426, and 428 are all the same.

However, in other embodiments, the image signals of the red, green, and blue fields are respectively S_{(Ra, Gb, Bc, Rd)}, S_{(Ga, Bb, Rc, Gd)}, and S_{(Ba, Rb, Gc, Bd)}. Additionally, the corresponding color sequences respectively received by the display regions 422, 424, 426, and 428 can be different. For example, referring to the schematic block diagrams shown in FIGS. 4A′ and 4B′, the corresponding color sequence of the signal received by the display region 422 is red→green→blue (that is, S_{Ra}→S_{Ga}→S_{Ba} in FIGS. 4A′ and 4B′). In addition, the corresponding color sequence of the signal received by the display region 424 is green→blue→red (that is, S_{Gb}→S_{Bb}→S_{Rb} in FIGS. 4A′ and 4B′). The corresponding color sequence of the signal received by the display region 426 is blue→red→green (that is, S_{Bc}→S_{Rc}→S_{Gc} in FIGS. 4A′ and 4B). The corresponding color sequence of the signal received by the display region 428 is red→green- blue (that is, S_{Rd}→S_{Gd}→S_{Bd} in FIGS. 4A′ and 4B′).

### The Fifth Embodiment

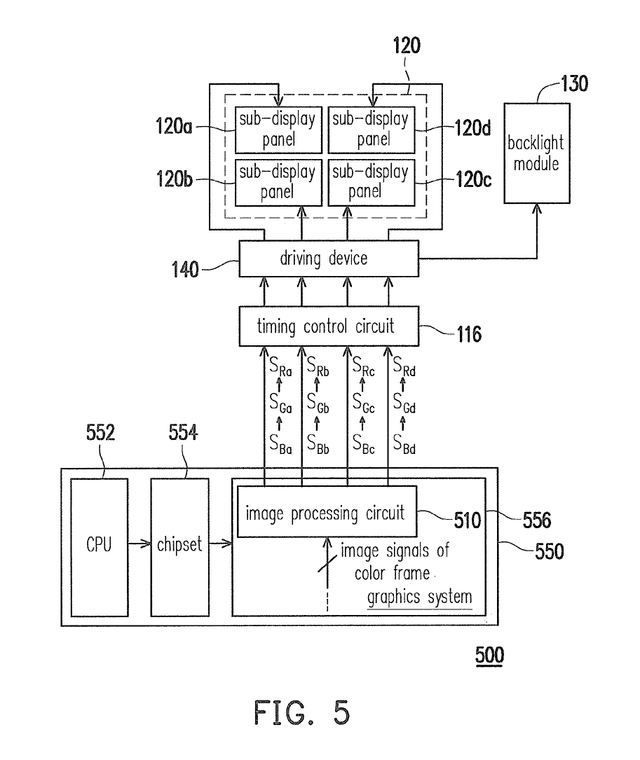

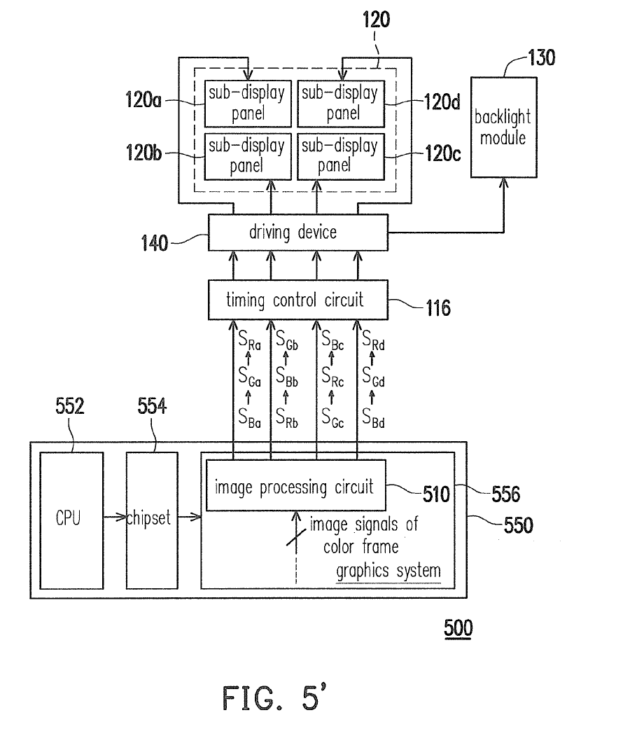

The concept to be illustrated in the present embodiment is similar to that of the first embodiment. The main difference between the two is that, in the present embodiment, as depicted in a color sequential display apparatus 500 of FIG. 5, an image processing circuit 510 is disposed in a graphics system 556 of a PC system 550, and the image processing circuit 510 shares the memory in the graphics system 556. Also, the same or similar reference numbers used in the present embodiment and in the aforementioned embodiment represent the same or the like components, and therefore no further description is provided herein.

Referring to FIG. 5, the PC system 550 of the present embodiment includes a CPU system 552, a chipset 554, and the graphics system 556. The chipset 554 is coupled between the CPU system 552 and the graphics system 556. The graphics system 556 includes the image processing circuit 510.

The framework of the image processing circuit 510 of the present embodiment can be the image processing circuit 110 in FIG. 1A, the image processing circuit 210 in FIG. 2, the image processing circuit 310 in FIG. 3, or the image processing circuit 310a in FIG. 3A. Therefore, the details of the image processing circuit 510 can refer to FIG. 1A, 2, 3, or 3A, and the descriptions thereof. The illustration is thus omitted herein.

Notably, in the present embodiment, the corresponding color sequences (i.e. red→green→blue) of the signals received by the sub-display panels 120a, 120b, 120c, and 120d respectively are all the same. In other embodiments, the corresponding color sequences of the signals received by the sub-display panels 120a, 120b, 120c, and 120d respectively can be all different.

For instance, referring to the schematic block diagram shown in FIG. 5′, the corresponding color sequence of the signal received by the sub-display panel 120a is red→green→blue (that is, S_{Ra}→S_{Ga}→S_{Ba} in FIG. 5′). In addition, the corresponding color sequence of the signal received by the sub-display panel 120b is green→blue→red (that is, S_{Gb}→S_{Bb}→S_{Rb} in FIG. 5). The corresponding color sequence of the signal received by the sub-display panel 120c is blue→red→green (that is, S_{Bc}→S_{Rc}→S_{Gc} in FIG. 5′). The corresponding color sequence of the signal received by the sub-display panel 120d is red→green→blue (that is, S_{Rd}→S_{Gd}→S_{Bd} in FIG. 5′).

### The Sixth Embodiment

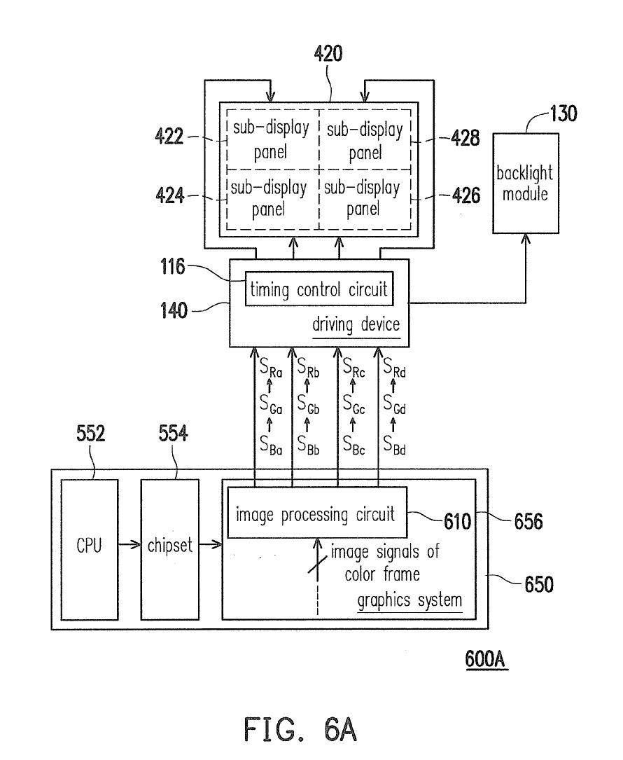

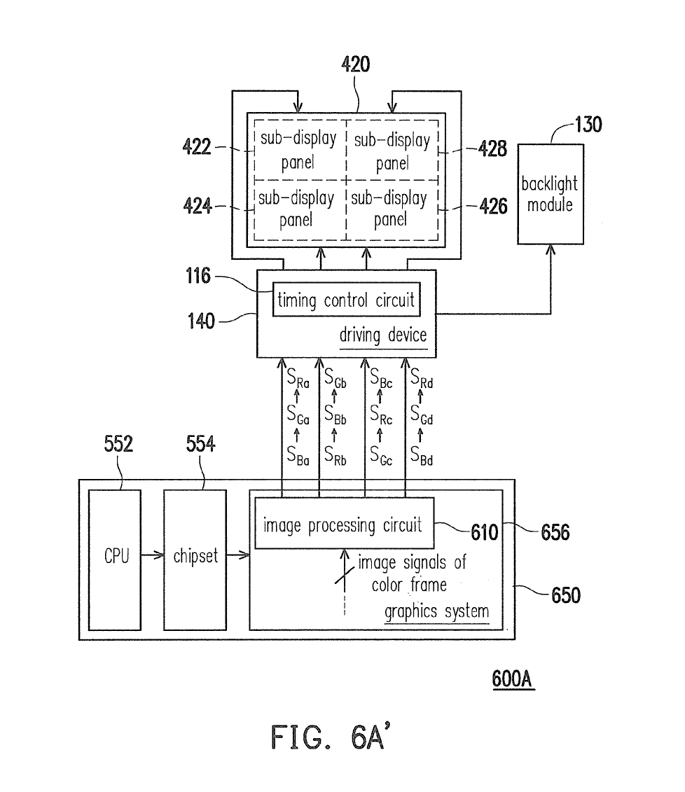

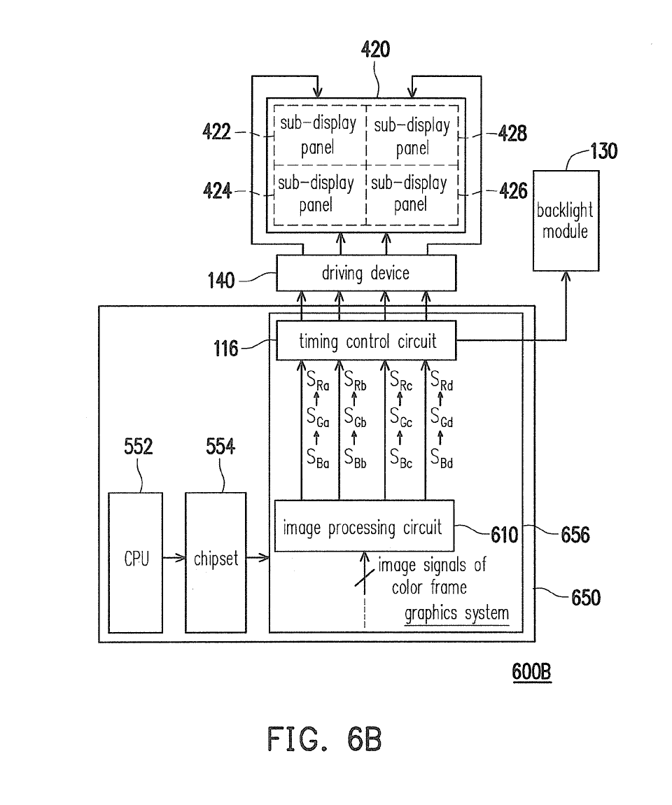

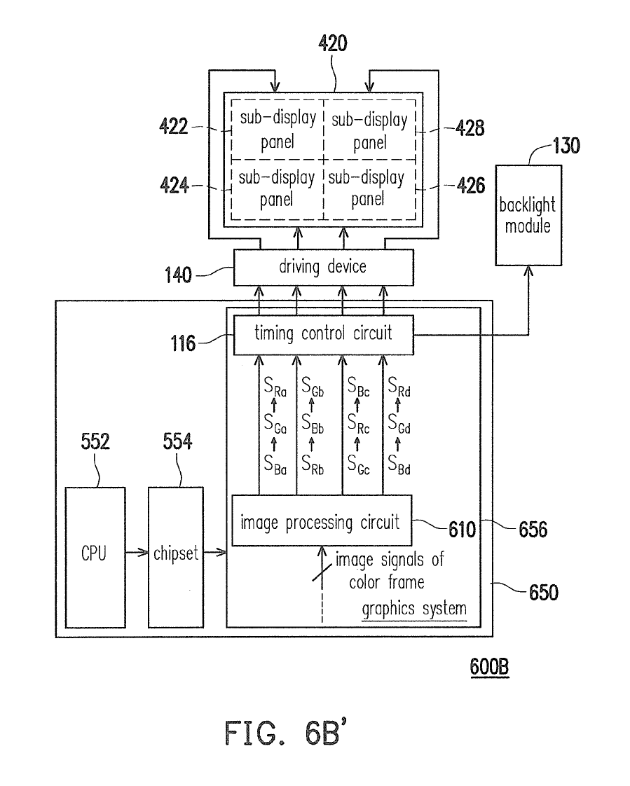

In the present embodiment, a plurality of sub-display panels in the fifth embodiment are integrated into a display panel 420. The display panel 420 has a plurality of display regions (to be described later) as color sequential display apparatuses 600A and 600B respectively illustrated in FIGS. 6A and 6B. The main difference between the two is that, the timing control circuit 116 in FIG. 6A is disposed in the driving device 140, and the timing control circuit 116 in FIG. 6B is disposed in the graphics system 656. The same or similar reference numbers used in the present embodiment and in the aforementioned embodiment represent the same or the like components, and therefore no further description is provided herein.

In the present embodiment, the display panel 420, for example, has four display regions 422, 424, 426, and 428. Obviously, the invention does not limit the display panel to be divided into four portions, and the number of division is determined upon actual requirements.

An image processing circuit 610 of the present embodiment is disposed in a graphics system 656 of a PC system 650. The image processing circuit 610 shares the memory inside the graphics system 656. The framework of the image processing circuit 610 can be the image processing circuit 110 in FIG. 1A, the image processing circuit 310 in FIG. 3, the image processing circuit 410a in FIG. 4A, or the image processing circuit 410b in FIG. 4B. The details of the image processing circuit 610 can refer to FIG. 1A, 3, 4A, or 4B and the descriptions thereof. The illustration is thus omitted herein.

Notably, in the present embodiment, the corresponding color sequences (i.e. red→green→blue) of the signals received by the display regions 422, 424, 426, and 428 respectively are all the same. In other embodiments, the corresponding color sequences of the signals received by the display regions 422, 424, 426, and 428 respectively can be all different.

For example, referring to the schematic block diagrams shown in FIGS. 6A′ and 6B′, the corresponding color sequence of the signal received by the display region 422 is red→green→blue (that is, S_{Ra}→S_{Ga}→S_{Ba} in FIGS. 6A′ and 6B′). In addition, the corresponding color sequence of the signal received by the display region 424 is green→blue→red (that is, S_{Gb}→S_{Bb}→S_{Rb} in FIGS. 6A′ and 6B). The corresponding color sequence of the signal received by the display region 426 is blue→red→green (that is, S_{Bc}→S_{Rc}→S_{Gc} in FIGS. 6A′ and 6B′). The corresponding color sequence of the signal received by the display region 428 is red- green→blue (that is, S_{Rd}→S_{Gd}→S_{Bd} in FIGS. 6A′ and 6B′).

### The Seventh Embodiment

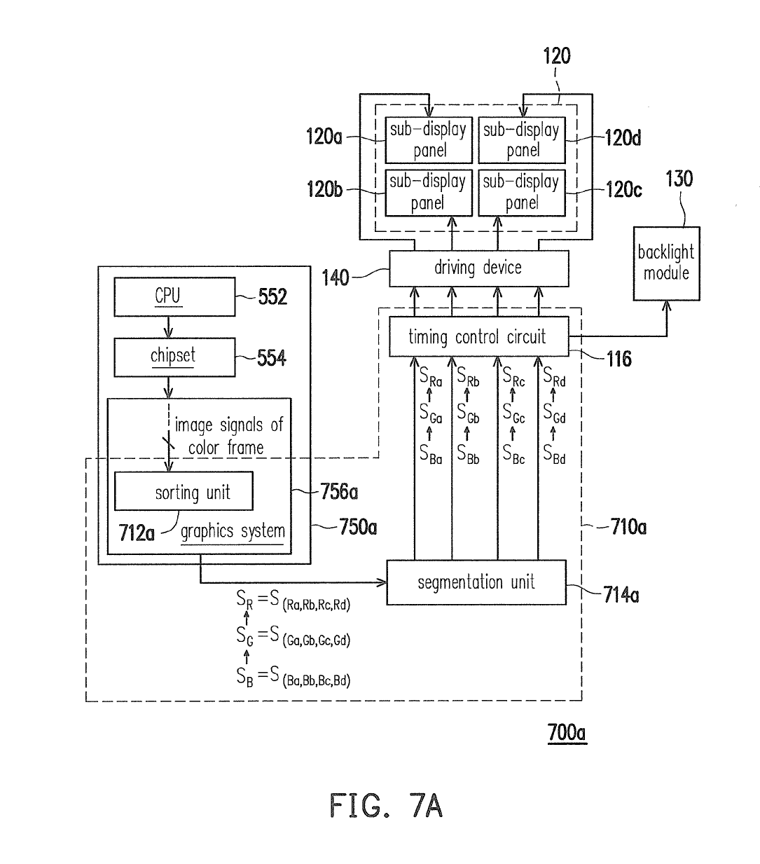

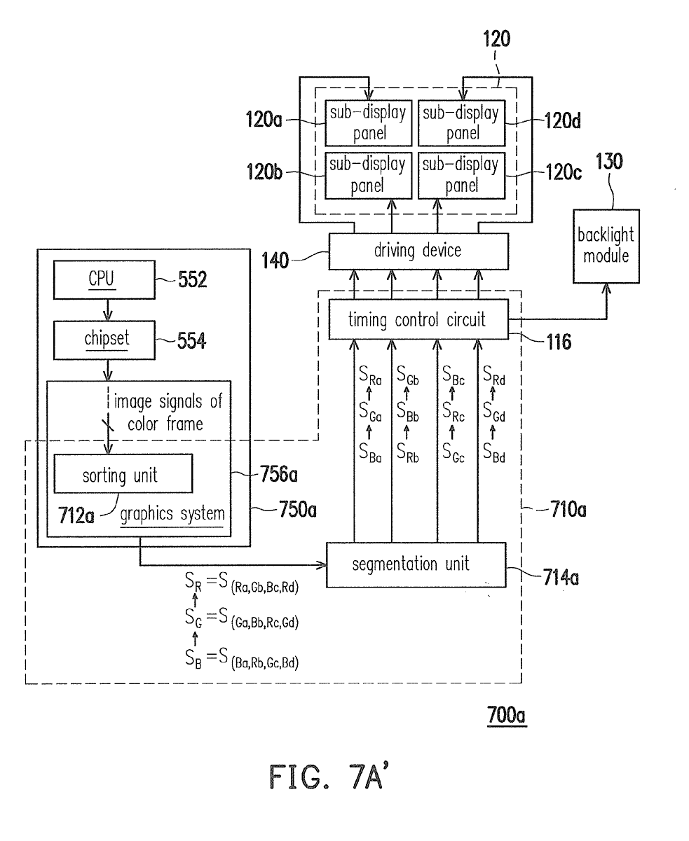

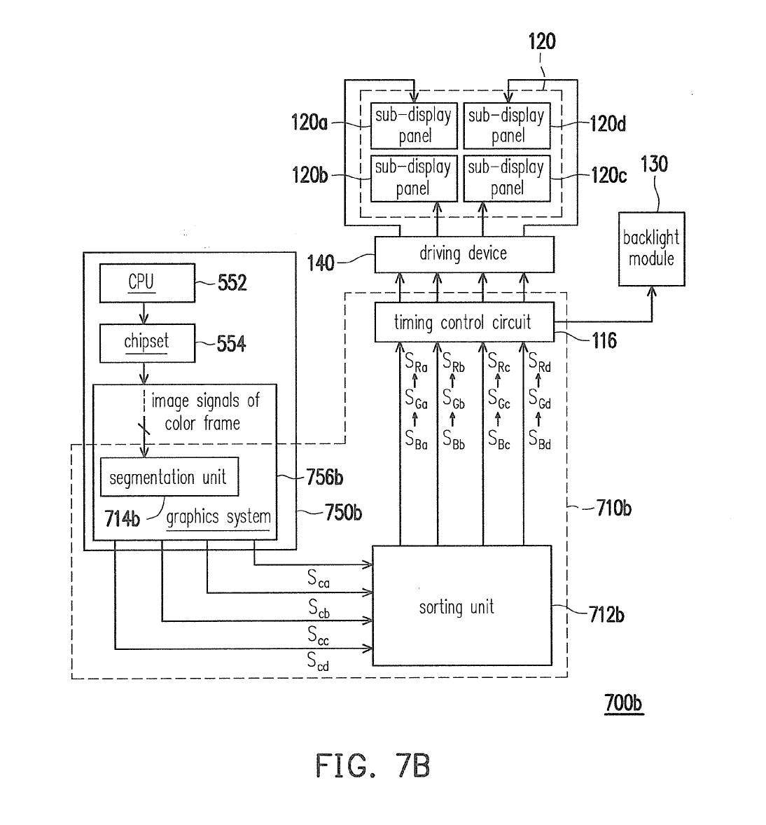

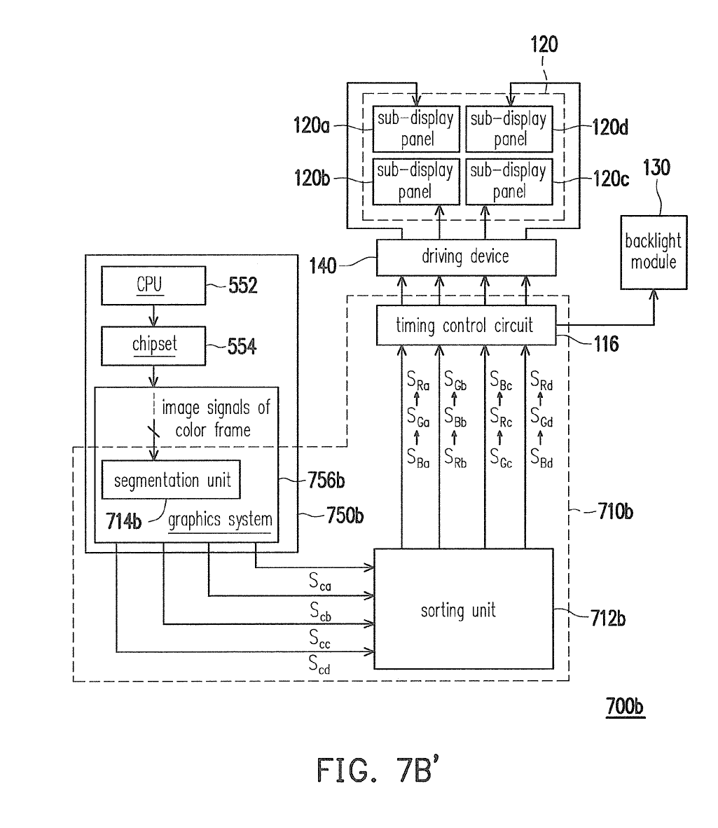

In the present embodiment, as shown in a color sequential display apparatus 700a of FIG. 7A, a part of the components in the image processing circuit of the fifth embodiment is disposed outside of the PC system. Additionally, the same or similar reference numbers used in the present embodiment and in the aforementioned embodiment represent the same or the like components, and therefore no further description is provided herein.

As aforementioned, an image processing circuit 710a of the present embodiment includes a plurality of components. A sorting unit 712a is disposed in a graphics system 756a of a PC system 750a. The segmentation unit 714a and the timing control circuit 116 are disposed outside of the PC system 750a.

It should be noted that in other embodiments, the sorting unit and the segmentation unit in FIG. 7A can be interchanged to faun a color sequential display apparatus 700b as depicted in FIG. 7B. As a consequence, a segmentation unit 714b is then disposed in a graphics system 756b of the PC system 750b. The sorting unit 712b and the timing control circuit 116 are disposed outside of a PC system 750b.

Obviously, other components, such as the shift unit (not shown) for shifting images, can be further disposed in the abovementioned image processing circuits 710a, 710b respectively. These components are disposed inside or outside of the PC systems 750a, 750b according to requirements of the product. The details of the image processing circuits 710a, 710b can refer to the fifth embodiment, and the description is thus omitted herein.

It should be noted that in the present embodiment, the image signals S_{R}, S_{G}, and S_{B} of the red, green, and blue fields are respectively S_{(Ra, Rb, Rc, Rd)}, S_{(Ga, Gb, Gc, Gd)}, and S_{(Ba, Bb, Bc, Bd)}. Moreover, the corresponding color sequences (i.e. red→green→blue) respectively received by the sub-display panels 120a, 120b, 120c, and 120d are all the same.

However, in other embodiments, the image signals of the red, green, and blue fields are respectively S_{(Ra, Gb, Bc, Rd)}, S_{(Ga, Bb, Rc, Gd)}, and S_{(Ba, Rb, Gc, Bd)}. Also, the corresponding color sequences respectively received by the sub-display panels 120a, 120b, 120c, and 120d can be different. For instance, referring to the schematic block diagrams shown in FIGS. 7A′ and 7B′, the corresponding color sequence of the signal received by the sub-display panel 120a is red→green→blue (that is, S_{Ra}→S_{Ga}→S_{Ba} in FIGS. 7A′ and 7B′). In addition, the corresponding color sequence of the signal received by the sub-display panel 120b is green→blue→red (that is, S_{Gb}→S_{Bb}→S_{Rb} in FIGS. 7A′ and 7B′). The corresponding color sequence of the signal received by the sub-display panel 120c is blue→red→green (that is, S_{Bc}→S_{Rc}→S_{Gc} in FIGS. 7A′ and 7B′). The corresponding color sequence of the signal received by the sub-display panel 120d is red→green→blue (that is, S_{Rd}→S_{Gd}→S_{Bd} in FIGS. 7A′ and 7B′).

### The Eighth Embodiment

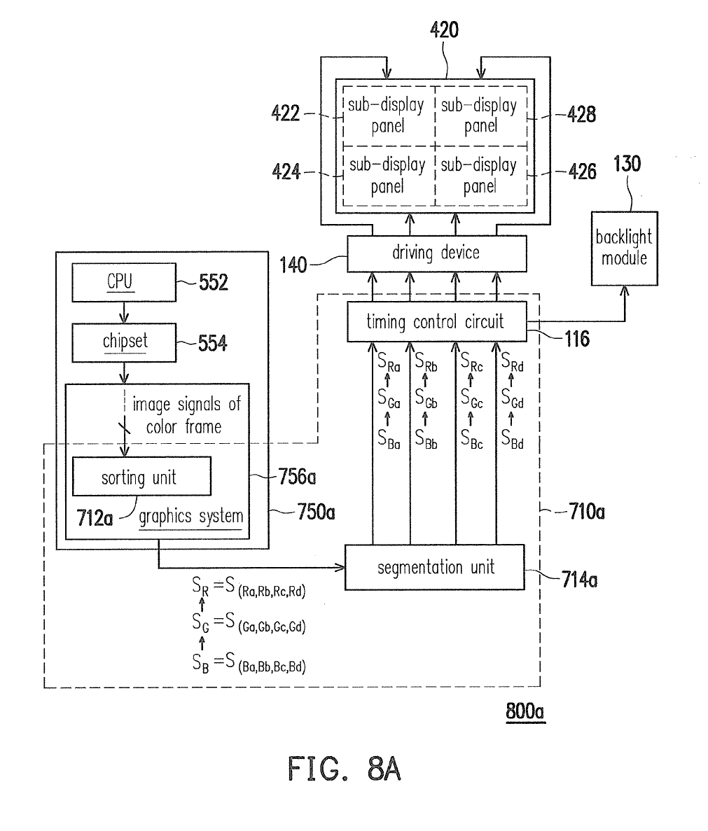

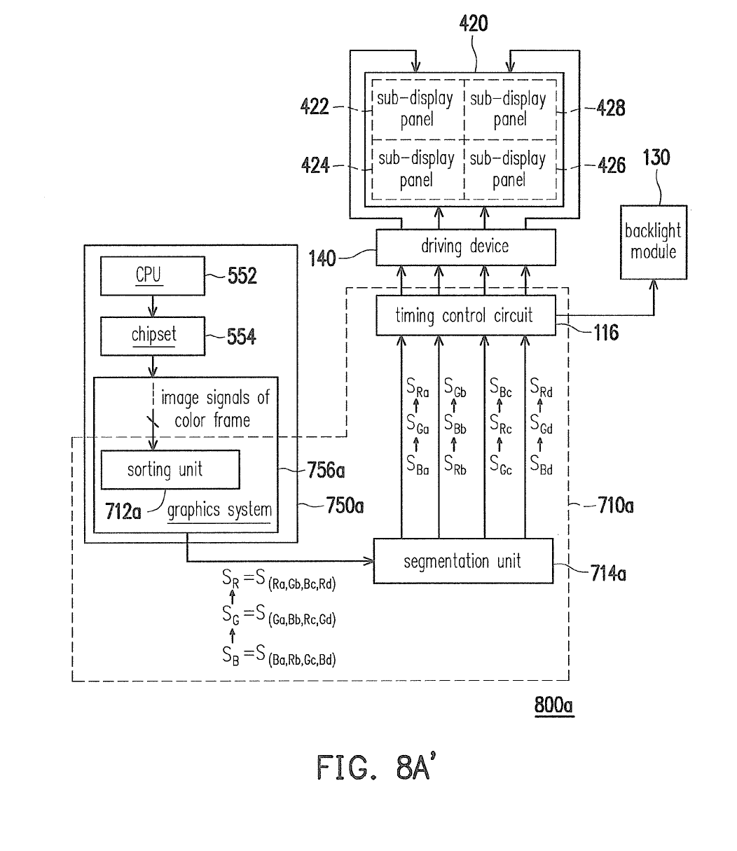

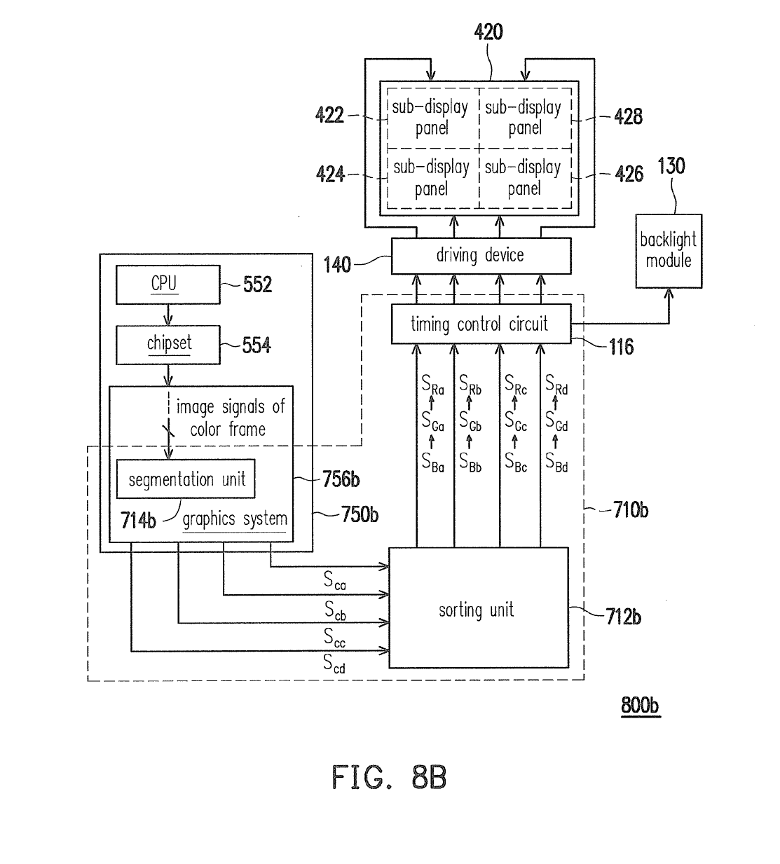

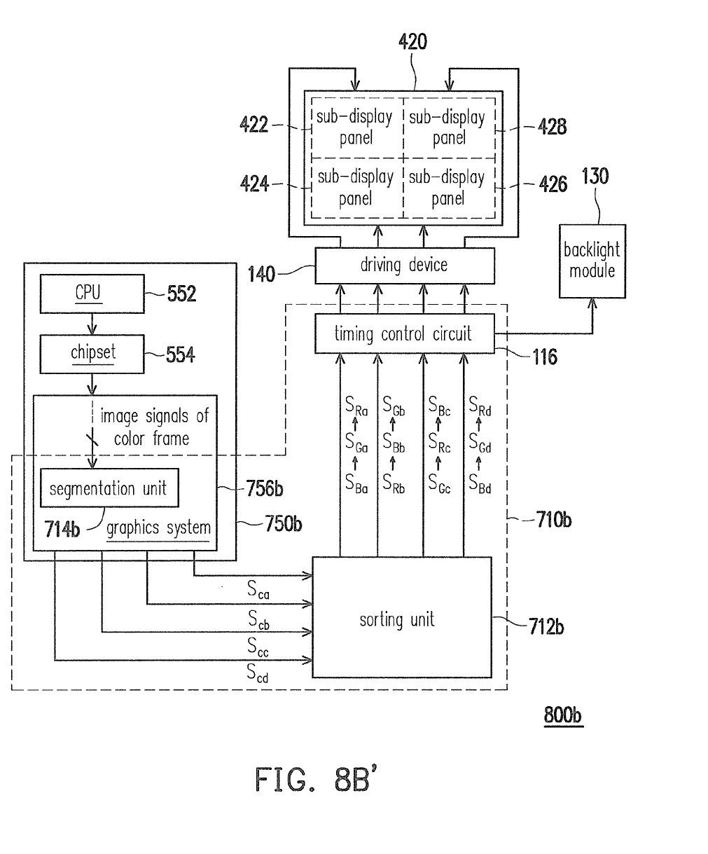

In the present embodiment, as color sequential display apparatuses depicted in FIGS. 8A, 8B, a plurality of sub-display panels in the seventh embodiment are further integrated into a display panel 420. The display panel 420 has a plurality of display regions. The same or similar reference numbers used in the present embodiment and in the aforementioned embodiment represent the same or the like components, and therefore no further description is provided herein.

It should be noted that in the present embodiment, the image signals S_{R}, S_{G}, and S_{B} of the red, green, and blue fields are respectively S_{(Ra, Rb, Rc, Rd)}, S_{(Ga, Gb, Gc, Gd)}, and S_{(Ba, Bb, Bc, Bd)}. Moreover, the corresponding color sequences (i.e. red→green→blue) respectively received by the display regions 422, 424, 426, and 428 are all the same.

However, in other embodiments, the image signals of the red, green, and blue fields are respectively S_{(Ra, Gb, Bc, Rd)}, S_{(Ga, Bb, Rc, Gd)}, and S_{(Ba, Rb, Gc, Bd)}. Also, the corresponding color sequences respectively received by the display regions 422, 424, 426, and 428 can be different. For example, referring to the schematic block diagrams shown in FIGS. 8A′ and 8B′, the corresponding color sequence of the signal received by the display region 422 is red→green→blue (that is, S_{Ra}→S_{Ga}→S_{Ba} in FIGS. 8A′ and 8B). In addition, the corresponding color sequence of the signal received by the display region 424 is green→blue→red (that is, S_{Gb}→S_{Bb}→S_{Rb} in FIGS. 8A′ and 8B′. The corresponding color sequence of the signal received by the display region 426 is blue→red→green (that is, S_{Bc}→S_{Rc}→S_{Gc} in FIGS. 8A′ and 8B′). The corresponding color sequence of the signal received by the display region 428 is red→green→blue (that is, S_{Rd}→S_{Gd}→S_{Bd} in FIGS. 8A′ and 8B′).

### The Ninth Embodiment

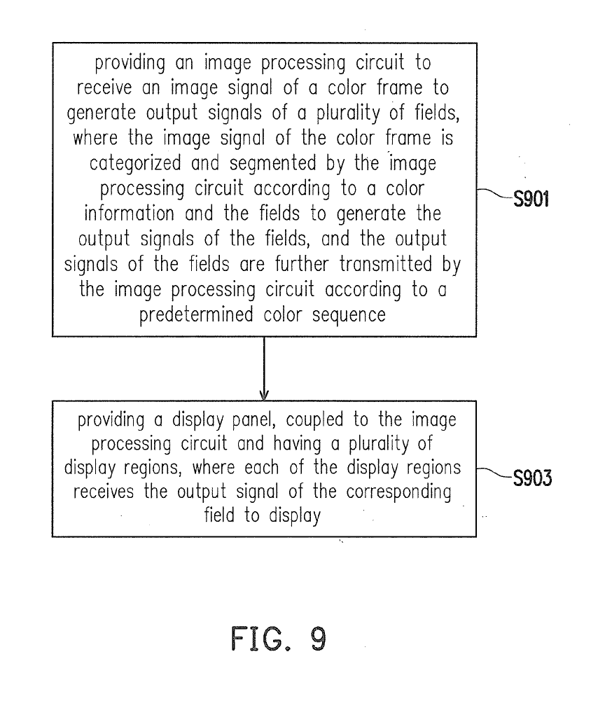

Summarizing the descriptions of the embodiments, the invention further provides a driving method of a color sequential display apparatus, as shown in FIG. 9. In step S901, an image processing circuit is provided to receive an image signal of a color frame to generate output signals of a plurality of fields. The image signal of the color frame is categorized and segmented by the image processing circuit according to a color information and the fields to generate the output signals of the fields. The output signals of the fields are further transmitted by the image processing circuit according to a predetermined color sequence. Moreover, in step S903, a display panel coupled to the image processing circuit and having a plurality of display regions is provided. Each of the display regions receives the output signal of the corresponding field to display. Nevertheless, the details of the driving method of the present embodiment can refer to the embodiments aforementioned, and the description is thus omitted herein.

In summary, the image processing circuit in the color sequential display apparatus of the invention categorizes and segments the image signal of the color frame received according to the color information. The image processing circuit further transmits the image signal according to the predetermined color sequence. Hence, the color sequential display apparatus of the invention not only provides superior display image, but also simplifies the design of transmission interface, thereby saving overall costs and reducing power consumption of the overall display system. The driving method of the color sequential display apparatus in the invention greatly enhances the display quality and reduces the power consumption and costs.

Although the invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A color sequential display apparatus, comprising:
an image processing circuit, receiving an image signal of a color frame to generate a plurality of output signals of a plurality of fields, wherein the image signal of the color frame are categorized and segmented by the image processing circuit according to a color information and the fields to generate the output signals of the fields, and the output signals of the fields are further transmitted by the image processing circuit according to a predetermined color sequence; and
a display panel, coupled to the image processing circuit and having a plurality of display regions, wherein each of the display regions receives the output signal of the corresponding field to display.

2. The color sequential display apparatus as claimed in claim 1, wherein the image processing circuit comprises:
a sorting unit, categorizing the image signal of the color frame into a plurality of image signals of a plurality of single-color fields and sorting the same according to the color information; and
a segmentation unit, coupled between the sorting unit and the display panel, segmenting the image signals of each of the single-color fields according to the color information and the fields so as to generate the output signals of the fields corresponding to the display regions.

3. The color sequential display apparatus as claimed in claim 2, wherein the single-color fields comprise a first color field and a second color field, the segmentation unit segments the image signals of the first color field to generate a part of the output signals of the fields corresponding to the display regions, and the segmentation unit segments the image signals of the second color field to generate another part of the output signals of the fields corresponding to the display regions.

4. The color sequential display apparatus as claimed in claim 3, wherein the single-color fields further comprise a third color field, the segmentation unit segments the image signals of the third color field to generate the output signals of further another part of the fields corresponding to the display regions.

5. The color sequential display apparatus as claimed in claim 2, wherein the image processing circuit further comprises:
a frame memory, coupled to the sorting unit and configured to store the image signals of the sorted single-color fields temporarily.

6. The color sequential display apparatus as claimed in claim 2, wherein the image processing circuit further comprises:
a shift unit, coupled between the segmentation unit and the display panel.

7. The color sequential display apparatus as claimed in claim 1, wherein the image processing circuit comprises:
a segmentation unit, segmenting the image signal of the color frame into a plurality of image signals of a plurality of color fields according to the color information and the fields, wherein the color fields correspond to the display regions respectively; and
a sorting unit, coupled between the segmentation unit and the display panel, and categorizing and sorting the image signals of each of the color frames so as to generate the output signals of the fields.

8. The color sequential display apparatus as claimed in claim 7, wherein the sorting unit categorizes and sorts the image signals of one of the color fields to generate a part of the output signals of the fields, and the sorting unit further categorizes and sorts the image signals of another one of the color fields to generate another part of the output signals of the fields.

9. The color sequential display apparatus as claimed in claim 8, wherein the sorting unit categorizes and sorts the image signals of further another one of the color fields to generate further another part of the output signals of the fields.

10. The color sequential display apparatus as claimed in claim 7, wherein the image processing circuit further comprises:
a frame memory, coupled to the sorting unit and configured to store the image signals of the sorted fields temporarily.

11. The color sequential display apparatus as claimed in claim 7, wherein the image processing circuit further comprises: a shift unit, coupled between the sorting unit and the display panel.

12. The color sequential display apparatus as claimed in claim 1, wherein the image processing circuit comprises:
a timing control circuit, coupled to the display panel and configured to output the output signals of the fields generated by the image processing circuit to the display panel.

13. The color sequential display apparatus as claimed in claim 1, further comprising:
a backlight module, turning on a corresponding backlight source according to the predetermined color sequence.

14. The color sequential display apparatus as claimed in claim 13, wherein the image processing circuit comprises:
a timing control circuit, coupled to the backlight module and the display panel, configured to output the output signals of the fields generated by the image processing circuit to the display panel, and configured to control the backlight module to turn on the backlight source corresponding to the output signals of the fields outputted by the image processing circuit.

15. The color sequential display apparatus as claimed in claim 1, wherein the predetermined color sequence is “red-green-blue”, “red-green-blue-green”, “red-green-blue-white”, “red-green-blue-white-yellow”, or “red-green-blue-cyan-yellow-magenta”.

16. A driving method of a color sequential display apparatus, comprising:
providing an image processing circuit to receive an image signal of a color frame to generate a plurality of output signals of a plurality of fields, wherein the image signal of the color frame is categorized and segmented by the image processing circuit according to a color information and the fields to generate the output signals of the fields, and the output signals of the fields are further transmitted by the image processing circuit according to a predetermined color sequence; and
providing a display panel, coupled to the image processing circuit and having a plurality of display regions, wherein each of the display regions receives the output signals of the corresponding field to display.

17. The driving method of the color sequential display apparatus as claimed in claim 16, wherein the step of “providing the image processing circuit to receive the image signal of the color frame to generate the output signals of the fields, wherein the image signal of the color frame is categorized and segmented by the image processing circuit according to the color information and the fields to generate the output signals of the fields, and the output signals of the fields are further transmitted by the image processing circuit according to the predetermined color sequence” comprises:
categorizing the image signal of the color frame into a plurality of image signals of a plurality of single-color fields and sorting the same according to the color information; and
segmenting the image signals of each of the single-color fields according to the color information and the fields so as to generate the output signals of the fields corresponding to the display regions.

18. The driving method of the color sequential display apparatus as claimed in claim 17, wherein the single-color fields comprise a first color field and a second color field, and the step of “segmenting the image signals of each of the single-color fields according to the color information and the fields so as to generate the output signals of the fields corresponding to the display regions” comprises:
segmenting the image signals of the first color field to generate a part of the output signals of the fields corresponding to the display regions; and
segmenting the image signals of the second color field to generate another part of the output signals of the fields corresponding to the display regions.

19. The driving method of the color sequential display apparatus as claimed in claim 18, wherein the single-color fields further comprise a third color field, and the step of “segmenting the image signals of each of the single-color fields according to the color information and the fields so as to generate the output signals of the fields corresponding to the display regions” comprises:
segmenting the image signals of the third color field to generate further another part of the output signals of the fields corresponding to the display regions.

20. The driving method of the color sequential display apparatus as claimed in claim 16, wherein the step of “providing the image processing circuit to receive the image signal of the color frame to generate the output signals of the fields, wherein the image signal of the color frame is categorized and segmented by the image processing circuit according to the color information and the fields to generate the output signals of the fields, and the output signals of the fields are further transmitted by the image processing circuit according to the predetermined color sequence” comprises:
segmenting the image signal of the color frame into a plurality of image signals of a plurality of color fields according to the color information and the fields, wherein the color fields correspond to the display regions respectively; and
categorizing and sorting the image signals of each of the color fields according to the color information so as to generate the output signals of the fields.

21. The driving method of the color sequential display apparatus as claimed in claim 20, wherein the step of “categorizing and sorting the image signals of each of the color fields according to the color information so as to generate the output signals of the fields” comprises:
categorizing and sorting the image signal of one of the color fields to generate a part of the output signals of the fields; and
categorizing and sorting the image signal of another one of the color fields to generate another part of the output signals of the fields.

22. The driving method of the color sequential display apparatus as claimed in claim 21, wherein the step of “categorizing and sorting the image signals of each of the color fields according to the color information so as to generate the output signals of the fields” further comprises:
categorizing and sorting the image signal of further another one of the color fields to generate further another part of the output signals of the fields.

23. The color sequential display apparatus as claimed in claim 16, further comprising:
providing a timing control circuit, coupled to the display panel and configured to output the output signals of the fields generated by the image processing circuit to the display panel.

24. The driving method of the color sequential display apparatus as claimed in claim 16, further comprising:
providing a backlight module, wherein the backlight module turns on a corresponding backlight source according to the predetermined color sequence.

25. The driving method of the color sequential display apparatus as claimed in claim 24, further comprising:
providing a timing control circuit, coupled to the backlight module and the display panel, configured to output the output signals of the fields generated by the image processing circuit to the display panel, and configured to control the backlight module to turn on the backlight source corresponding to the output signals of the fields outputted by the image processing circuit.

26. The driving method of the color sequential display apparatus as claimed in claim 16, wherein the predetermined color sequence is “red-green-blue”, “red-green-blue-green”, “red-green-blue-white”, “red-green-blue-white-yellow”, or “red-green-blue-cyan-yellow-magenta”.
